(19) United States
(12) Patent Application Publication
(10) Pub. No.: US 2014/0344590 A1
(43) Pub. Date: Nov. 20, 2014

(54) ELECTRONIC DEVICE AND POWER MANAGEMENT METHOD

(71) Applicant: FIH (Hong Kong) Limited, Kowloon (HK)

(72) Inventor: JO-CHIEN CHANG, Shindian (TW)

(73) Assignee: FIH (HONG KONG) LIMITED, Kowloon (HK)

(21) Appl. No.: 14/217,490

(22) Filed: Mar. 18, 2014

(30) Foreign Application Priority Data
May 15, 2013 (TW) 102117179

(51) Int. Cl. G06F 1/26

(52) U.S. Cl. CPC G06F 1/26
USPC 713/300

(57) ABSTRACT

An electronic device includes a central processing unit (CPU), a plurality of power driving circuits, and a control unit. The control unit includes a microcontroller and a storage electronically connected to the microcontroller, the microcontroller is electronically connected to the CPU and the power driving circuits. The CPU stores control programs in the storage via the microcontroller, the microcontroller reads the control programs from the storage, and controls the power driving circuits according to the control programs.

### BACKGROUND

1. Technical Field

The disclosure generally relates to electronic devices, and particularly to an electronic device having a power management function and a power management method of the electronic device.

2. Description of the Related Art

Electronic devices (e.g., mobile phone) often employ a power management unit (PMU) to manage power to power a plurality of circuit modules (e.g., WIFI module). However, the PMU is directed by a central processing unit (CPU), when the CPU is not startup, the PWU may not control the circuit modules.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present embodiments.

FIG. 1 is a block diagram of one embodiment of an electronic device.

FIG. 2 is a flowchart of one embodiment of a power management method of the electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

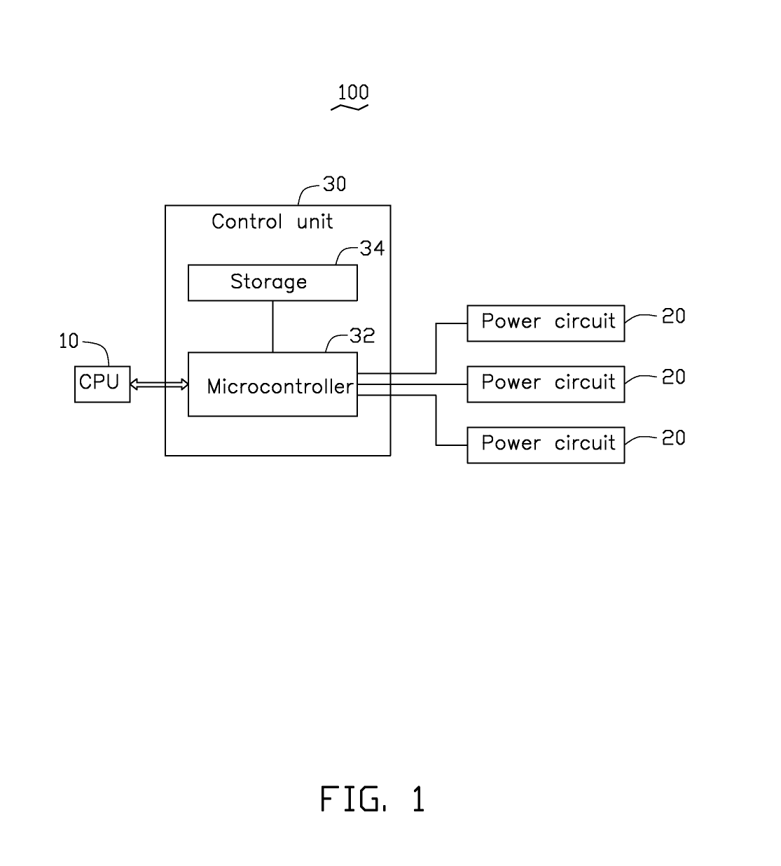

FIG. 1 shows an electronic device 100 according to an exemplary embodiment. The electronic device 100 may be a mobile phone or a personal digital assistant, for example.

The electronic device 100 includes a central processing unit (CPU) 10, a plurality of power driving circuits 20, and a control unit 30. The CPU 10 and the control unit 30 are configured to manage the power driving circuits 20. The power driving circuits 20 may include a light emitting diode (LED) circuit, a WIFI circuit, and a radio frequency (RF) circuit.

The CPU 10 is electronically connected to the control unit 30 via an I2C bus, and executes control programs in the control unit 30. The control programs are used to control the power driving circuits 20. For example, a first control program is used to activate the LED circuit, and a second control program is used to activate the WIFI circuit.

In addition, the CPU 10 updates the control programs to control other power driving circuits 20, such as a microphone circuit, for example.

The control unit 30 includes a microcontroller 32 and a storage 34. In one exemplary embodiment, the microcontroller 32 is a power management unit (PMU) electronically connected to the CPU 10 via the I2C bus, to receive the control programs from the CPU 10. The microcontroller 32 is electronically connected to the storage 34, to write/read the control programs in/from the storage 34. In one exemplary embodiment, the microcontroller 32 is powered by a battery of the electronic device 100. Additionally, the microcontroller 32 processes the control programs to control the power driving circuits 20. For example, when a control program that is used to control the LED circuit is processed by the microcontroller 32, the LED circuit is activated.

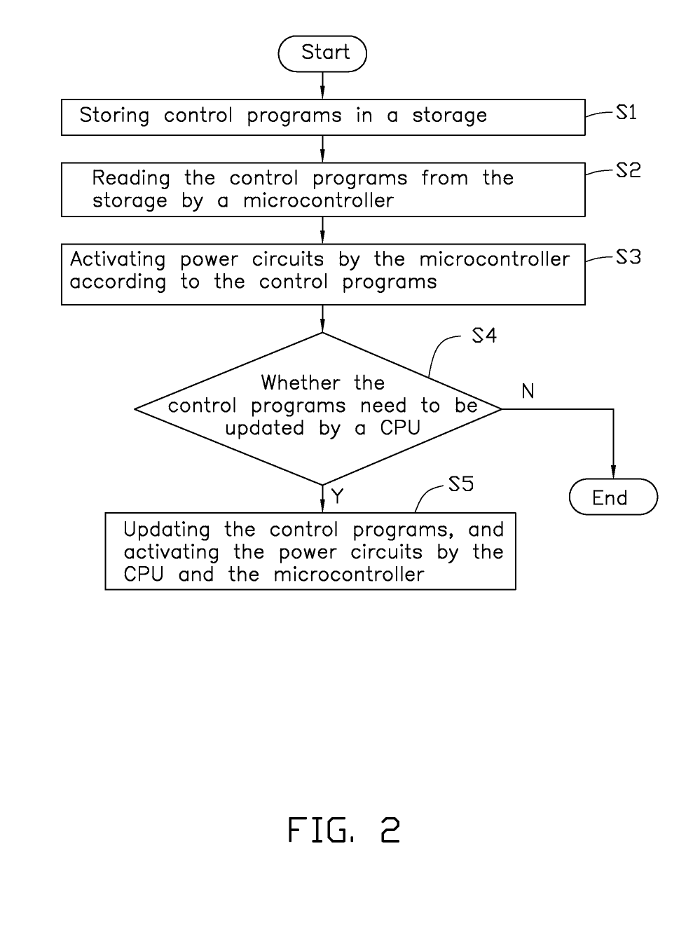

FIG. 2 is a flowchart of one embodiment of a power management method of the electronic device 100. Depending on the embodiment, additional blocks may be added to the flowchart, others removed, and the ordering of the blocks may be changed.

In block S1, the CPU 10 stores the control programs in the storage 34 via the I2C bus and the microcontroller 32.

In block S2, when the electronic device 100 is turned off, the CPU 10 is not powered accordingly, then the microcontroller 32 reads the control programs from the storage 34.

In block S3, the microcontroller 32 processes the control programs, and controls the power driving circuits 20 accordingly. For example, the microcontroller 32 activates the RF circuit according to a first control program, to receive short message, and then the microcontroller 32 activates the LED circuit according to a second control program, to light one or more LEDs, thereby notifying a user.

In block S4, when the electronic device 100 is turned on, the CPU 10 is powered accordingly, whether the control programs need to be updated by the CPU 10 is manually determined.

In block S5, if the control programs need to be updated, the CPU 10 updates the control programs, and then the CPU 10 and the microcontroller 32 jointly activate the power driving circuits 20. If the control programs do not need to be updated, the microcontroller 32 continues to control the power driving circuits 20 alone.

In summary, the CPU 10 stores the control programs in the storage 34, when the electronic device 100 is turned off, the microcontroller 32 reads the control programs from the storage 34, and controls the power driving circuits 20 accordingly. Therefore, some base function, such as short message notification, cannot be influenced even through the electronic device 100 is turned off. Thus, the electronic device 100 is both convenient and efficient.

Although numerous characteristics and advantages of the exemplary embodiments have been set forth in the foregoing description, together with details of the structures and functions of the exemplary embodiments, the disclosure is illustrative only, and changes may be made in detail, especially in the matters of arrangement of parts within the principles of disclosure to the full extent indicated by the broad general meaning of the terms in which the appended claims are expressed.

What is claimed is:

1. An electronic device, comprising:
a central processing unit (CPU),
a plurality of power driving circuits; and
a control unit comprising a microcontroller and a storage electronically connected to the microcontroller, the microcontroller electronically connected to the CPU and the power driving circuits;
wherein the CPU stores control programs in the storage via the microcontroller, the microcontroller reads the control programs from the storage, and controls the power driving circuits according to the control programs.

2. The electronic device as claimed in claim 1, wherein the CPU updates the control programs.

3. The electronic device as claimed in claim 1, wherein the microcontroller is electronically connected to the CPU via an I2C bus.

4. The electronic device as claimed in claim 1, wherein if the electronic device is turned on, the CPU and the microcontroller jointly activate the power driving circuits; if the electronic device is turned off, the microcontroller activates the power driving circuits alone.

5. The electronic device as claimed in claim 1, wherein the microcontroller is a power management unit (PMU).

6. An electronic device, comprising:
a central processing unit (CPU),
a plurality of power driving circuits; and
a control unit comprising a microcontroller and a storage electronically connected to the microcontroller, the microcontroller electronically connected to the CPU and the power driving circuits;
wherein the CPU stores control programs in the storage via the microcontroller, if the electronic device is turned off, the microcontroller activates the power driving circuits alone according to the control programs; if the electronic device is turned on, the CPU and the microcontroller jointly activate the power driving circuits according to the control programs.

7. The electronic device as claimed in claim 6, wherein the CPU updates the control programs.

8. The electronic device as claimed in claim 6, wherein the microcontroller is electronically connected to the CPU via an I2C bus.

9. A power management method of an electronic device, the electronic device comprising a central processing unit (CPU), a plurality of power driving circuits; a microcontroller, and a storage, the power management method comprising:
storing control programs in the storage via the CPU;
reading the control programs from the storage via the microcontroller; and
activating the power driving circuits via the microcontroller.

10. The power management method of claim 9, further comprising updating the control programs via the CPU.
